(19) United States
(12) Patent Application Publication
(10) Pub. No.: US 2010/0064544 A1
(43) Pub. Date: Mar. 18, 2010

(54) Magnetic shoe-drying apparatus

(76) Inventors: Huan V. Luong, Seattle, WA (US); Howard H. Lin, Fairbanks, AK (US)

Correspondence Address: Huan V. Luong, 1421 NW 63rd Apt. 5, Seattle, WA, 98107, US

(21) Appl. No.: 12/283,402

(22) Filed: Sep. 12, 2008

(51) Int. Cl. F26B 25/00; A47G 35/00

(52) U.S. Cl. 34/239; 248/206.5

(57) ABSTRACT

A magnetic shoe-drying apparatus is to improve shoe drying in a conventional laundry dryer. The apparatus is comprised of a magnet plat and at least one strap. The straps are to fasten a wet shoe onto the magnetic plate and the magnetic plate serves as a way to stick the shoe to the drum, inside a laundry, so that the shoe will not tumble when the dryer is in operation. Several pieces of the apparatus can be placed in the dryer and hence several wet shoes can be dried simultaneously. Wet clothes can also be dried together with wet shoes using this apparatus.

### DISCUSSION OF BACKGROUND ART

Tennis shoes and other athletic shoes have been very popular since the second half of the 20^{th} century. Almost every household in the U.S. has at least one pair of sneakers. These shoes require little maintenance, only periodic washing and drying. The washing process is similar to the regular laundry procedure, which involves a conventional washing machine. After the wash, these shoes can be dried in the sun or, more typically, in a conventional automatic laundry dryer.

When a laundry dryer is used to dry wet shoes, the shoes tumble continuously during the drying process. This creates a very noisy and unpleasant environment for the surrounding. In addition, the tumbling action causes tearing, that often damages the shoes. For the above reasons, people are usually forced to dry their wet sneakers in the sun, rather than in a dryer. The fall back of this method is it takes a long time, and the shoes usually are not efficiently dried.

We think there is a need for improving the drying process of shoes in conventional laundry dryers. The idea is to use a device that would eliminate banging noise and reduce the damages due to tumbling.

### SUMMARY OF THE INVENTION

The present invention is directed to improve drying of tennis shoes and other athletic shoes in a conventional laundry dryer. Sandals and slippers can also be dried using this invention in conjunction with a dryer. In the present invention, a magnetic plate with a strap or straps is provided to improve the process of drying wet shoes.

To use the magnetic shoe-drying apparatus of this invention, the wet shoe is first attached to the magnetic plate and secured onto the plate by the straps. The strapped shoe is then magnetically stuck onto the dryer's drum, inside the dryer, by the magnetic action of the plate. When the dryer is turned on, the shoe is firmly stuck to the drum of the dryer and thus does not tumble freely. Several magnetic shoe plates with straps and hence several wet shoes can be placed in a dryer at the same time. Wet clothes also can be dried together with the strapped shoes. When the drying process is over, the strapped shoes are then removed by pulling the plates and shoes from the dryer's drum.

### BRIEF DESCRIPTION OF THE DRAWINGS

The accompanying drawings which are incorporated in and constitute a part of the specification, schematically illustrate the preferred embodiments of the invention, and together with the general description of the preferred embodiments given below, serve to explain the principle of the invention.

FIG. 1 is a schematic view of a first preferred embodiment of the present invention with two straps.

FIG. 2 is a schematic view of a modified embodiment of the present invention with two straps.

### DETAILED DESCRIPTION OF THE INVENTION

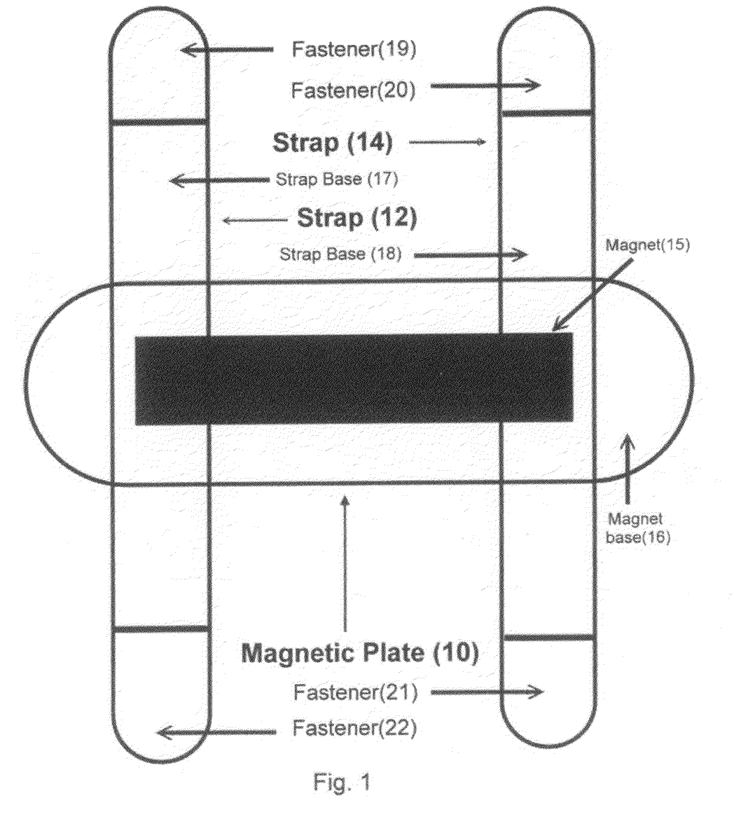

Referring to FIG. 1, the apparatus of the invention is comprised of two major components: magnetic plate 10 and straps 12 and 14. The straps are to wrap and fix the shoe onto the magnetic plate. The magnetic plate serves as a way to stick the shoe to the drum, inside laundry dryer.

The magnetic plate consists of at least one magnet 15 and a magnet base 16. A preferred material for the magnet is ceramic permanent magnets such as that manufactured by Eriez Magnetics of Erie, Pa., USA. Some metallic magnets can also be used satisfactorily. The magnet is attached to or covered by the magnet base by gluing or sewing. Fabric, plastic or metals can be used satisfactorily for the magnet base. Satisfactory lengths of the magnetic plate range between 8 inches and 16 inches. A preferred width of the magnetic plate is between 2 inches and 5 inches. The thickness of the magnetic plate is preferred to be in a range between 0.25 inches and 1 inch. As shown in FIG. 1, two straps 12 and 14 are attached to the magnetic plate 10. However, it will be understood that one strap or more than two straps can also be used. The strap consists of two components, a strap base 17 or 18 and fasteners 19 and 22, or 20 and 21, which together form a tight and secure strap. Velcro system is the preferred method for fastening a shoe onto the magnetic plate, although other system such as buckles and clips can also be used. In the case of Velcro, the system is “hook and loop fasteners” in which the hooks are made of fabric covered with tiny hooks, and the loops are made of tiny hairy loops. The strap base is made of metal, plastic or fabric.

Those skilled in the art may select to attach the Velcro fastener to the whole length of the strap base without departing from the spirit of the present invention. Satisfactory lengths of the straps range between approximately 14 inches and 24 inches. The widths of the straps are preferred to be in a range between 1 inch and 4 inches.

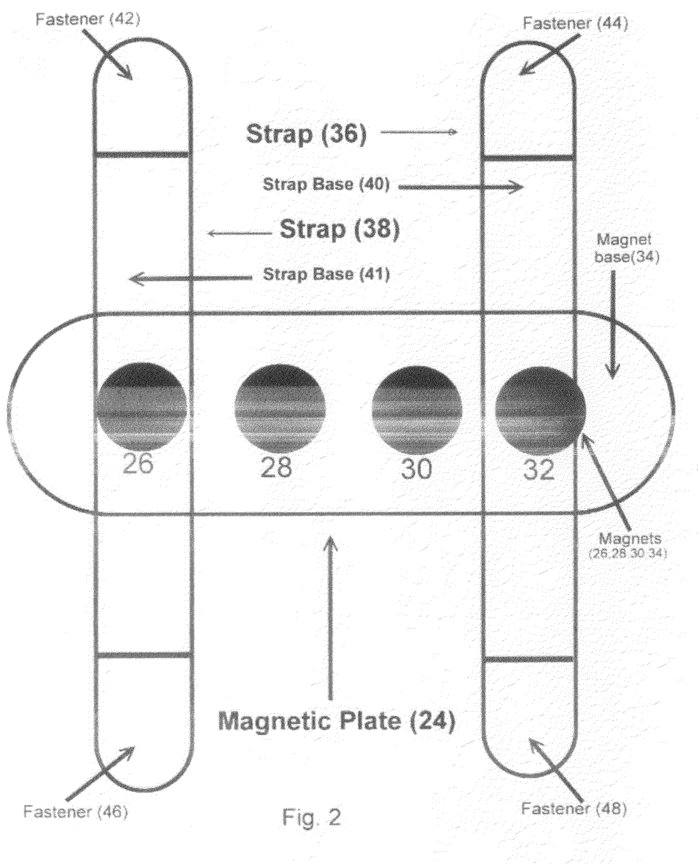

In a modified embodiment of the invention, as shown in FIG. 2, the magnetic plate 24 is fabricated by embedding or attaching 2 to 5 pieces of circular shapes of magnets 26, 28, 30 and 32 to a magnet base 34. However, it will be understood that the cross-section of magnets of rectangle or other shapes can also be used. Metal, fabric and plastic are the preferred materials for the magnet base. Satisfactory lengths of the magnetic plate range between 8 inches and 16 inches. A preferred width of the magnetic plate is between 2 inches and 5 inches. The thickness of the magnetic plate is preferred to be in a range between 0.25 inches and 1 inch. Fabric or plastic material is used to coat the magnet plate when a metal is selected as the material for the magnet base.

As shown in FIG. 2, two straps 36 and 38 are attached to the magnetic plate 24. However, it will be understood that one strap or more than two straps can also be used. The strap consists of two components: a strap base 40 or 41 made of fabric or plastic and fasteners 42 and 46, or 44 and 48 which are sewed or glued to the strap base. Velcro fastener is a preferred fastener for fastening a shoe onto the magnetic plate although other fastener such as buckles and clips can also be used satisfactorily. When Velcro fasteners are used, preferably a section of the Velcro fastener is attached to each end of the strap base. Those skilled in the art may select to attach the Velcro fastener to the whole length of the strap base without departing from the spirit of the present invention. Satisfactory lengths of the straps range between approximately 14 inches and 24 inches. The widths of the straps are preferred to be in a range between 1 inch and 4 inches.

The present investigation has been described and depicted as a preferred embodiment. The embodiment, however, is not limited to be embodiment described and depicted. Rather the invention is defined by the claims appended hereto.

What is claimed is:

1. A magnet plate with straps for holding a shoe onto the drum of a conventional laundry dryer, comprising of:
(a) A magnet plate consisting of at least one magnet and magnet base and
(b) At least one strap consisting of a strap base and fasteners.

2. The apparatus of claim 1, wherein the magnet plate has a length between approximately 8 inches and 16 inches.

3. The apparatus of claim 1, wherein the magnet plate has a width between approximately 2 inches and 5 inches.

4. The apparatus of claim 1, wherein the magnet plate has a thickness between approximately 0.25 inches and 1 inch.

5. The apparatus of claim 1, wherein the magnet is selected from ceramic magnets and metallic magnets.

6. The apparatus of claim 1, wherein the magnet base is selected from a group of materials consisting of metal, fabric and plastic.

7. The apparatus of claim 1, wherein the strap has a length between approximately 14 inches and 24 inches.

8. The apparatus of claim 1, wherein the strap has a width between approximately 1 inch and 5 inches.

9. The apparatus of claim 1, wherein the strap base is made of plastic or fabric.

10. The apparatus of claim 1, wherein the fastener is selected from a group of fasteners of Velcro fastener, buckle and clips fastener and string fastener.
